(19) United States
(12) Patent Application Publication
(10) Pub. No.: US 2004/0137185 A1
(43) Pub. Date: Jul. 15, 2004

(54) Self-adhesive band with improved adhesive properties for sealing gaps in building construction

(76) Inventors: Reto Sieber, Sigigien (CH); Marco Sieber, Horw (CH)

Correspondence Address: JORDAN AND HAMBURG LLP, 122 EAST 42ND STREET, SUITE 4000, NEW YORK, NY, 10168, US

(21) Appl. No.: 10/250,809

(22) PCT Filed: Feb. 18, 2002
(86) PCT No.: PCT/EP02/01701

(30) Foreign Application Priority Data
Mar. 11, 2001 (DE) 101 22 882.1

(51) Int. Cl. B32B 15/04; B32B 7/12

(52) U.S. Cl. 428/41.8; 428/343

(57) ABSTRACT

The invention relates to a self-adhesive band for closing, sealing and glueing gaps in building construction, more particularly gaps in corners and edges, comprising a carrier layer (1) on the upper side of the band and an adhesive layer (2) on the bottom side of the band, said adhesive layer being provided with a tear-off cover film (3). According to the invention, at least one lateral longitudinal segment (7) is provided in which both the carrier layer (1) and the adhesive layer (2) are perforated.

The present invention relates to a pressure-sensitive tape for closing off, sealing and gluing of joints in house construction, especially of joints in corners or at edges. Such adhesive tapes are also referred to as assembly adhesive tapes, vapor retardant adhesive tapes or vapor retardant films. They are used especially for sealing joints between window frames and door frames and the corresponding edges of the respective wall openings. It is a requirement here that, on the one hand, the adhesive tapes adhere well to different substrates and, on the other, that the pressure-sensitive tape can be applied easily, that is, glued easily. A different application of such pressure-sensitive tapes consists of sealing joints between individual components, such as corners between the external walls of houses. The sealing function of the tapes consists of closing off the joints as airtight and permanently as possible.

As a rule, such adhesive tapes have a backing layer and an adhesive layer, which is connected with the backing layer, the adhesive layer being provided with a covering film, which can be pulled off, as protection for the adhesive. After the covering film is pulled off, the tape is glued initially to the one edge of the joint and, subsequently to the other edge.

One problem of such adhesive tape consists therein that the adhesive layer must be adapted to different substrates. For example, the adhesive layer must adhere equally to wood or plastic and to a slightly porous substrate, such as plaster, wall plaster, concrete or bricks. A further problem of the known assembly adhesive tapes consists therein that, due to a subsequent further processing at the upper side of the adhesive tape, for example, by plastering the walls, the danger exists that the adhesive tape will detach from the substrate and therefore the joints, which are to be sealed, begin to leak.

It is therefore an object of the present invention to make available a pressure-sensitive tape for sealing, closing off and gluing joints, the adhesion properties of which are optimized with respect to further processing with plaster or the like. It is a further object of the invention to make available a pressure-sensitive tape for sealing joints, which can be fabricated inexpensively and, nevertheless, ensures a good and permanent sealing function.

This objective is accomplished with a pressure-sensitive tape with the distinguishing features named in claim 1. Further refinements and developments are the object of the dependent claims.

The inventive tape has a backing, on which an adhesive layer is applied, for example, by a coating process. The adhesive layer, in turn, is provided with a covering film, which can be pulled off and is also referred to as liner or protector, in order to protect the adhesive layer against contamination and the like and to enable the adhesive tape to be wound up even if the adhesive is very tacky. Pursuant to the invention, the tape has at least one lateral, longitudinal section, that is, one region at a longitudinal side of the adhesive tape, in which the backing and the adhesive layer are perforated. Perforated means that at least one row of openings, passing through the backing and the adhesive layer, is provided. The adhesion of the tape during a subsequent plastering with plaster or gypsum or the like is improved by the perforations, because the plaster adheres in the openings of the perforations directly to the substrate and so reinforces the adhesion of the tape even to a porous substrate. By these means, it is prevented that, due to the moisture and the weight of an applied layer of plaster or the like, the tape can become detached from the substrate and develop leaks or that the plaster layer can break up. Even if wallpaper or a decoration panel is subsequently glued over the tape, the connection of the adhesive layer to the substrate is improved. The perforating is provided only at one lateral longitudinal section of the adhesive tape, so that the central, adhering region can reliably ensure the sealing function of the adhesive tape. The perforating of the lateral, longitudinal section of the adhesive tape can be formed by essentially circular, angular or oval openings, which preferably are distributed uniformly. By these means, it is achieved that the adhesion function of the adhesive layer is adversely affected as little as possible and, nevertheless, penetration of a layer of a material, applied on the adhesive tape, through the openings to the substrate, to which the adhesive tape is glued, can take place.

In an advantageous embodiment of the invention, the openings of the perforated, longitudinal section have an average diameter of at least 3 millimeters.

Advantageously, the openings are essentially circular, angular or oval.

According to an advantageous development of the invention, two lateral, longitudinal sections are provided, which are perforated. With such an adhesive tape, joints between components in interior construction can be sealed, the adhesive tape on either side of the joint subsequently being touched up with a layer of material. Nevertheless, independently of the thickness of the plaster layer, which is to be applied on the adhesive tape, the area of the joint does not leak, because the center of the adhesive tape is not perforated. The section, which is not perforated, is wider than the maximum width of the joint which is to be sealed.

According to a further, advantageous development of the invention, a non-adhesive central strip is provided and the perforated longitudinal section is at a distance from the central strip. This has the advantage that the tape can be glued smoothly without crinkling in corners and at edges, since the non-adhesive central strip makes it possible to press the tape into corners without adhering immediately and without forming folds during the gluing. Because the perforated, longitudinal section is at a distance from the central strip, it is prevented that the perforation openings lead to leaks, when the joint, which is to be sealed, is covered with the non-adhesive central strip.

According to a further, advantageous development of the invention, the backing, the adhesive layer and the covering film, which can be pulled off, are perforated. This has the advantage that the tape can be fabricated easily. In this connection, the covering film prevents contact between the perforating tool, such as a stamping device, and the adhesive layer of the pressure-sensitive tape.

According to a further, advantageous development of the invention, the backing consists of a material which has good adhesive properties for wall plaster. Such good adhesive properties are ensured, for example, by an open-pored material. The connection between the wall plaster and the backing and, accordingly, also the adhesive connection between the tape and the substrate are improved by these means. Any detachment or breaking off of parts of the wall plaster is reliably avoided.

According to a further, advantageous development of the invention, the covering film has at least one slit in the longitudinal direction. The tape may be folded onto itself along the slit in such a manner that at least a portion of the covering film is disposed on the outside. By these means, the tape can also be glued easily in edge and corner regions, since, to begin with, a portion of the covering film can be pulled off and this portion of the tape glued. At the same time, the adhesive layer of the other part of the tape remains protected and cannot adhere unintentionally at the sides. The processing of the adhesive tape in areas, to which access is difficult, or in corners is also simplified by these means. Nevertheless, a secure hold is assured by the inventive adhesive tape owing to the fact that the perforation openings permit a layer, such as plaster, which is to be applied subsequently on at least a portion of the tape, to penetrate partially.

A further advantageous embodiment of the invention consists therein that the edge of the backing, on the upper side, has an adhering section, which is provided with a covering film, which can be pulled off. This has the advantage that the sealing tape can be glued to a window frame or door frame, before the latter is installed in a brickwork opening. After the installation, the other adhesive regions can be glued to the brickwork and optionally plastered. By these means, special joints with special problems because of corner regions and the like can also be sealed off airtight with the tape.

The invention is described in greater detail in the following by means of examples with references to the drawings, in which

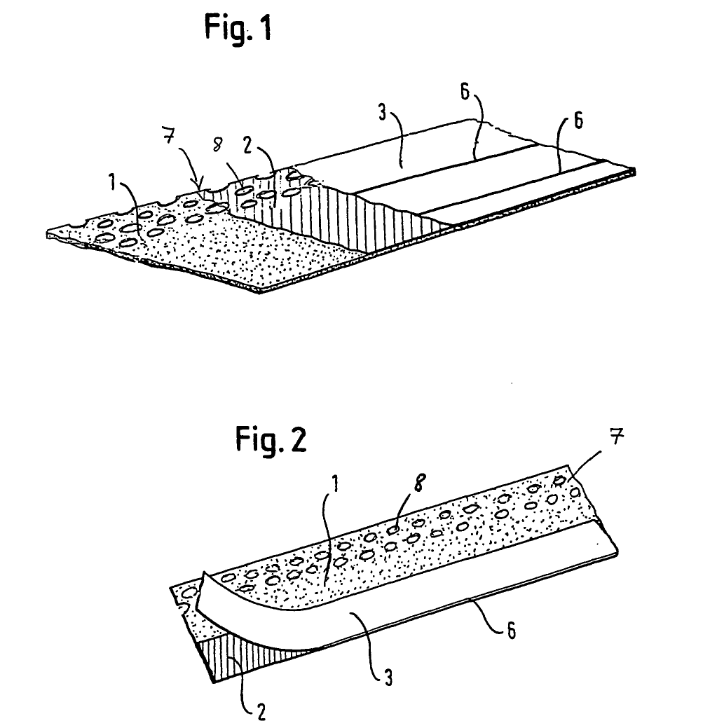

FIG. 1 shows a first example of an inventive pressure-sensitive tape with a perforated, longitudinal section,

FIG. 2 shows an adhesive tape of FIG. 1, the tape being partially folded here onto itself and

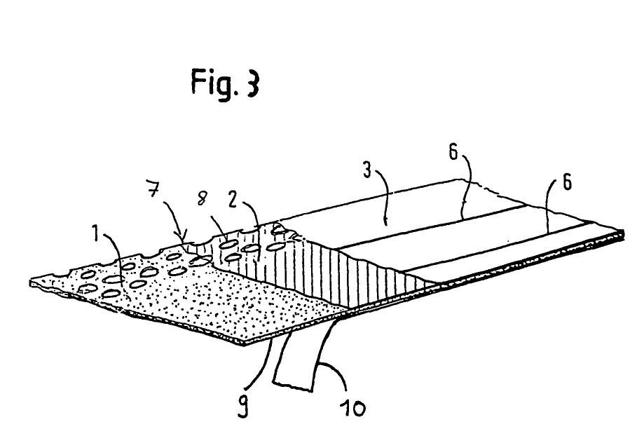

FIG. 3 shows a second example of an inventive, pressure-sensitive tape with a perforated, longitudinal section and an adhesive edge section at the upper side.

FIG. 1 shows an assembly adhesive tape 1, which has a backing 1, an adhesive layer 2 and a covering film 3, which is provided at the adhesive layer 2. In the case of this example, the covering film 3 has two slits 6 in the longitudinal direction of the tape. Alternatively, the covering film may also have no slits or only a single slit 6. In a longitudinal section 7 of the assembly adhesive tape, the backing 1 and the adhesive layer 2 are perforated, that is, provided with several openings, which pass through the backing 1 and the adhesive layer 2. The perforation of the longitudinal section 7 may consist, as in the example shown, of circular openings 8 or of openings in an angular, oval or undefined form. The openings of the perforation of the longitudinal section 7 can be disposed uniformly distributed or become smaller or reduced in number in the direction of the lateral edge of the assembly adhesive tape. Preferably, the perforation openings in the longitudinal section 7 have an average diameter of at least 3 mm, so that sufficient penetration of plaster, which is applied on the backing after the assembly adhesive tape is processed, is ensured. The plaster brings about an additional holding effect by combining with the substrate. With that, when the assembly adhesive tape is glued, the adhesive effect is reduced in the longitudinal section 7 of the perforation because of the openings of the perforation, which are present. Subsequently, however, this reduction is more than compensated for by the wall plaster, which is to be applied. Advantageously, it is avoided that such a load is exerted on the backing of the adhesive tape by a layer of wall plaster or the like that the adhesive tape runs the danger that it will become detached from the substrate and leak.

The assembly adhesive tape of FIG. 1 is shown in FIG. 2, a portion of the adhesive tape being folded onto itself here. Accordingly, a prefolded assembly adhesive tape is formed, which is prefolded in such a manner at the slit 6 of the covering film 3, that initially a portion of the covering film 3 can be pulled off and glued easily, for example, at an edge or in a corner region, before the other portion of the covering film 3 (in FIG. 2, on the reverse side of the adhesive tape, which is not shown) can be pulled off and glued. The openings 8 of the perforated longitudinal section 7 of the adhesive tape are distributed uniformly and are circular in the case of this example. They may, however, also have a different shape or be distributed nonuniformly over the longitudinal section 7.

FIG. 3 shows a further example of the invention, the upper side edge of the backing having an adhesive section 9, which is provided with a covering film 10, which can be pulled off. In FIG. 3, the viewing angle of the inventive pressure-sensitive tape is selected, so that this tape is seen from its underside. The representation of the assembly adhesive tape of FIG. 3 otherwise corresponds to that of the assembly adhesive tape of FIG. 1, the reference symbols for identical distinguishing features being identical.

1. A pressure-sensitive tape for closing off, sealing and gluing joints in house construction, especially joints in corners and at edges, with a backing (1) on the upper side of the tape of and with an adhesive layer (2), which is provided on the underside of the tape and has a covering film (3), which can be pulled off, characterized in that at least one lateral longitudinal section (7) is provided, in which the backing (1) and the adhesive layer (2) are perforated.

2. The tape of claim 1, characterized in that two lateral longitudinal sections (7, 7′) are provided, which are perforated.

3. The tape of one of the claims 1 or 2, characterized in that a non-adhesive central strip is provided and the perforated longitudinal section (7, 7′) is at a distance from the central strip.

4. The tape of one of the claims 1 to 3, characterized in that the backing (1), the adhesive layer (2) and the covering film (3), which can be pulled off, are perforated.

5. The tape of one of the claims 1 to 4, characterized in that the backing (1) consists of such a material, especially an open-pored material, that it has good adhesive properties for wall plaster.

6. The tape of one of the claims 1 to 5, characterized in that the perforated longitudinal section (7, 7′) has openings (8) with an average diameter of at least 3 millimeters.

7. The tape of claim 6, characterized in that the openings (8) are essentially circular, angular or oval.

8. The tape of one of the preceding claims, characterized in that the covering film (3) has at least one slit (6) in the longitudinal direction.

9. The tape of claim 8, characterized in that the tape is folded onto itself along the slit (6), so that at least a portion of the covering film (3) is disposed on the outside.

10. The tape of one of the preceding claims, characterized in that the upper side of the backing (1) has a pressure-sensitive edge section, which is provided with a covering film, which can be pulled off.
